(19) United States
(12) Patent Application Publication
(10) Pub. No.: US 2015/0210109 A1
(43) Pub. Date: Jul. 30, 2015

(54) MOTOR VEHICLE WHEEL

(71) Applicant: Dr. Ing. h.c.F. Porsche Aktiengesellschaft, Stuttgart (DE)

(72) Inventors: Georg Von Tardy-Tuch, Kapfenhardt (DE); Achim Schulz, Niefern-Oeschelbronn (DE)

(21) Appl. No.: 14/408,805

(22) PCT Filed: May 8, 2013
(86) PCT No.: PCT/EP2013/001369

§ 371 Date: Dec. 17, 2014

(30) Foreign Application Priority Data
Jun. 28, 2012 (DE) 10 2012 105 656.0

(51) Int. Cl. B60B 3/00; B60B 3/10; B60B 3/02

(52) U.S. Cl. CPC B60B 3/005; B60B 3/02; B60B 3/10; B60B 2900/111; B60B 2900/311; B60B 2900/711

(57) ABSTRACT

A motor vehicle wheel with a radially inner hub and a radially outer rim. The rim has an axially inner internal rim flange, which faces the motor vehicle in the installation position, on a first side, an axially outer external rim flange, which faces away from the motor vehicle in the installation position, on a second side, and a rim base, which is positioned between the two flanges. At least one circular hollow chamber which runs in the circumferential direction is formed between the rim and the hub in the radial direction in the region of the second side.

### CROSS-REFERENCE TO RELATED APPLICATIONS

This is a U.S. National Phase Patent Application of PCT International Patent Application Number PCT/EP2013/001369, filed May 8, 2013, which claims priority benefit of DE 10 2012 105 656.0, filed Jun. 28, 2012, each of which is incorporated herein by reference in its entirety.

### FIELD OF THE INVENTION

The invention relates to a motor vehicle wheel with a radially inner hub and a radially outer rim, wherein the rim has an axially inner internal rim flange, which faces the motor vehicle in the installed position, on a first side, an axially outer external rim flange, which faces away from the motor vehicle in the installed position, on a second side, and a rim base which is positioned between said two rim flanges, wherein at least one hollow chamber encircling in the circumferential direction is formed in the radial direction between the rim and the hub in the region of the second side.

### BACKGROUND OF THE INVENTION

According to the prior art, a motor vehicle wheel comprises a radially inner hub and a radially outer rim, wherein a “wheel disk”, which can be provided, for example, by spoke-shaped elements, is positioned between the radially inner hub and the radially outer rim, as seen in the radial direction. The radially outer rim of a motor vehicle wheel comprises an “internal rim flange”, an “external rim flange” and via a rim base positioned between said two rim flanges, wherein rim shoulders provide a transition region between the rim base and the two rim flanges. The internal rim flange of the rim is formed on that side of the wheel which faces the motor vehicle in the installed position of the wheel. The external rim flange is formed on that side of the wheel which faces away from the motor vehicle in the installed position of the wheel.

### SUMMARY OF THE INVENTION

Motor vehicle wheels which are lightweight, have a high degree of rigidity and can withstand high loads are basically desired. There is therefore a need for a novel motor vehicle wheel which meets these requirements.

Taking this as the starting point, the present invention relates to providing a novel motor vehicle wheel.

Described herein is a motor vehicle wheel with a radially inner hub and a radially outer rim, wherein the rim has an axially inner internal rim flange, which faces the motor vehicle in the installed position, on a first side, an axially outer external rim flange, which faces away from the motor vehicle in the installed position, on a second side, and a rim base which is positioned between said two rim flanges, wherein at least one hollow ling in the circumferential direction is formed in the radial direction between the rim and the hub in the region of the second side.

According to aspects of the invention, at least one hollow chamber encircling in the circumferential direction is formed in the radial direction between the rim and the hub in the region of the second side.

A lightweight and rigid motor vehicle wheel which can withstand high loads can be provided via at least one hollow chamber which encircles in the circumferential direction and is positioned in the radial direction between the radially outer rim and the radially inner hub. Such a motor vehicle wheel has a relatively low weight.

According to a first advantageous development of the invention, the motor vehicle wheel has a single hollow chamber which encircles in the circumferential direction and directly adjoins the hub in the radial direction, wherein intermediate elements having apertures positioned therebetween in the circumferential direction are formed between the hollow chamber and the rim. Such a motor vehicle wheel, in which the single hollow chamber which encircles in the circumferential direction and adjoins a hub, as seen in the radial direction, is of advantage in particular in the case of large rim widths.

According to a second, alternative advantageous development of the invention, the motor vehicle wheel has a single hollow chamber which encircles in the circumferential direction and directly adjoins the rim in the radial direction, wherein intermediate elements having apertures positioned therebetween in the circumferential direction are formed between the hollow chamber and the hub. Such a configuration of the motor vehicle wheel, in which the single hollow chamber encircling in the circumferential direction adjoins the rim, is suitable in particular in the case of motor vehicle wheels having small rim widths.

According to a third, alternative advantageous development of the invention, the motor vehicle wheel has a single hollow chamber which encircles in the circumferential direction and extends between the rim and the hub. Such a configuration of the motor vehicle wheel according to aspects of the invention is of advantage in particular if venting of the motor vehicle wheel is not required.

According to a fourth, alternative advantageous development of the invention, the motor vehicle wheel has two hollow chambers encircling in the circumferential direction, namely a first hollow chamber which directly adjoins the rim in the radial direction, and a second hollow chamber which directly adjoins the hub. The rigidity can be further increased via two hollow chambers encircling in the circumferential direction. Venting of the motor vehicle wheel is possible via intermediate elements positioned between the two encircling hollow chambers, as seen in the radial direction.

The intermediate elements are preferably designed as spokes extending substantially the radial direction or as struts extending substantially in the axial direction. Whenever struts extending substantially in the axial direction are used as intermediate elements, the compression/tension load-bearing capacity of the motor vehicle wheel can be further improved.

The or each hollow chamber is preferably bounded axially by in each case two frustoconically contoured profiles which are spaced apart in the axial direction, and radially by the hub and/or the rim. The use of two frustoconically contoured profiles for forming each hollow chamber is structurally preferred, since the or each hollow chamber can be provided in a simple manner with such a construction.

### BRIEF DESCRIPTION OF THE DRAWINGS

Preferred developments of the invention emerge through the dependent claims and the description below. Exemplary embodiments of the invention are explained in more detail, without being restricted thereto, with reference to the drawing, in which:

FIGS. 1a, 1b show schematized views of a first exemplary embodiment of a motor vehicle wheel;

FIG. 2 shows a schematized view of a second exemplary embodiment of a motor vehicle wheel;

FIG. 3 shows a schematized view of a third exemplary embodiment of a motor vehicle wheel;

FIGS. 4a, 4b show schematized views of a fourth exemplary embodiment of a motor vehicle wheel;

FIG. 5 shows a schematized view of a fifth exemplary embodiment of a motor vehicle wheel; and

FIG. 6 shows a schematized view of a sixth exemplary embodiment of a motor vehicle wheel.

### DETAILED DESCRIPTION OF THE INVENTION

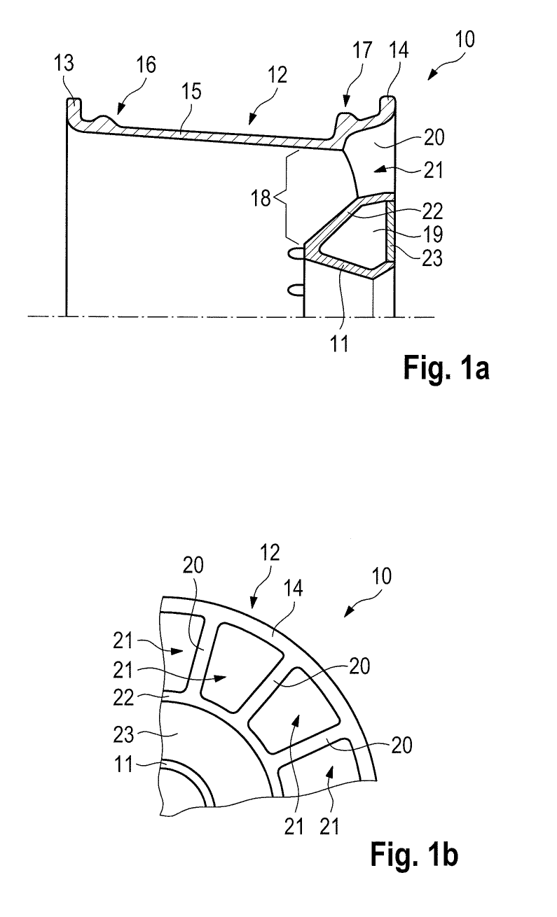

FIGS. 1a and 1b show different views of a motor vehicle wheel 10 according to aspects of the invention, wherein the motor vehicle wheel 10 comprises a radially inner hub 11 and a radially outer rim 12. The rim 12 has an axially inner internal rim flange 13, which faces the motor vehicle in the installed position of the motor vehicle wheel 10, on a first side, and an axially outer external rim flange 14, which faces away from the motor vehicle in the installed position of the motor vehicle wheel 10, on an opposite second side. A “rim base” 15 is positioned between the internal rim flange 13 and the external rim flange 14, wherein rim shoulders 16, 17 form a transition region between the rim base 15 and the respective rim flange 13 or 14. The region between the radially inner hub 11 and the radially outer rim 12 is also referred to as the wheel disk 18.

Within the context of the present invention here, at least one hollow chamber 19 encircling in the circumferential direction is formed radially between the rim 12 and the hub 11 in the region of the second side of the motor vehicle wheel 10, i.e. in the region of the side which faces away from the motor vehicle in the installed position of the motor vehicle wheel 10. A lightweight and rigid motor vehicle wheel which can withstand high loads can thereby be provided.

In the exemplary embodiment shown in FIGS. 1a and 1b, there is a single hollow chamber 19 which encircles in the circumferential direction and directly adjoins the hub 11 in the radial direction, wherein intermediate elements 20 having apertures 21 positioned therebetween in the circumferential direction are formed between the hollow chamber 19 and the radially outer rim 12.

In the exemplary embodiment shown in FIGS. 1a and 1b, the intermediate elements 20 are designed as spokes 20 extending substantially in the radial direction.

In the exemplary embodiment of FIGS. 1a and 1b, the single hollow chamber 19 is bounded in the axial direction by two frustoconically contoured profiles 22, 23 which are spaced apart in the axial direction, and radially by the hub 11, wherein one of the frustoconically contoured profiles, namely the profile 22 in FIG. 1a, is an integral part of the hub 11. The other frustoconically contoured profile 23 is welded to the first frustospherically contoured profile 22 and to the hub 11.

All of the assemblies are preferably produced from a similar metallic material. In particular, laser welding, electron beam welding or else friction welding serves as the welding method for connecting the profile 23 to the profile 22 and to the hub 11.

Accordingly, in the exemplary embodiment of FIGS. 1a and 1b, there is a single hollow chamber 90 which encircles in the circumferential direction and directly adjoins the hub 11, as seen in the radial direction. Such a configuration is suitable in particular in the case of large rim widths of the motor vehicle wheel 10.

The wheel 10 is vented via the apertures 21 which are formed between the intermediate elements 20 designed as spokes.

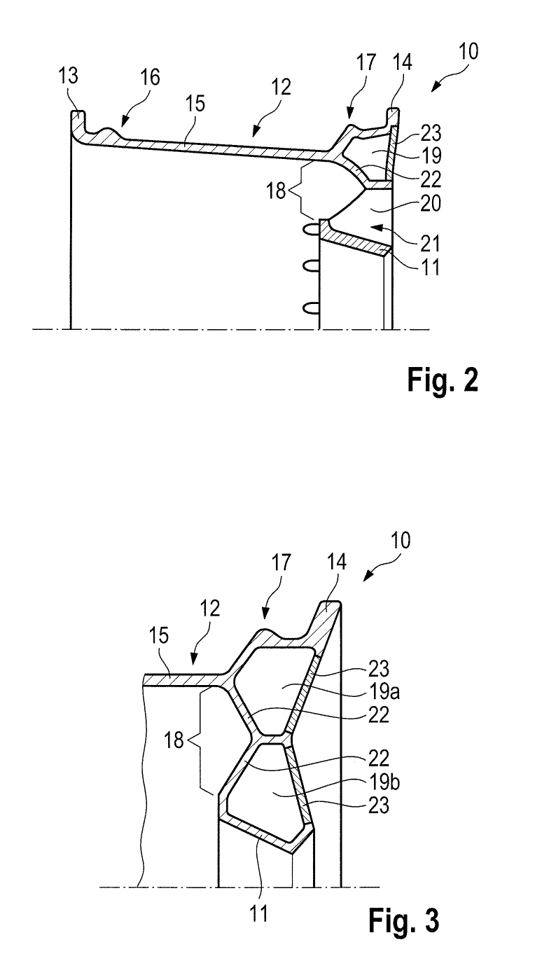

FIG. 2 clarifies an exemplary embodiment of the invention, in which, again, there is a single hollow chamber 19 which encircles in the circumferential direction but which directly adjoins the rim 12, as seen in the radial direction, wherein the intermediate elements 20 having the apertures 21 formed therebetween are formed and positioned between the hollow chamber 19 and the hub 11.

Also in the exemplary embodiment of FIG. 2, the hollow chamber 19 is bounded, as seen in the axial direction, by two axially spaced-apart and frustoconically contoured profiles 22, 23, wherein, in FIG. 2, the hollow chamber 19 is bounded in the radial direction by the rim 12, namely by the external rim flange 14 and by the rim shoulder 17 adjoining the external rim flange 14.

The frustoconically contoured profile 22 which, in the exemplary embodiment of FIG. 2, is an integral part of the rim 12 branches off from the rim base 12 at the lowest point of same.

The other frustoconically contoured profile 23 is welded to the frustoconically contoured profile 22 and to the rim 12.

FIG. 3 shows an exemplary embodiment of a motor vehicle wheel 10 according to aspects of the invention, in which there are two hollow chambers 19a, 19b encircling in the circumferential direction, namely a first hollow chamber 19a which directly adjoins the rim 12 in the radial direction, and a second hollow chamber 19b which directly adjoins the hub 11 in the radial direction.

In the variants of the invention shown in FIG. 3, there are no apertures for ventilating the wheel 10, but it is also possible for one of the hollow chambers 19a, 19b or for the two hollow chambers 19a, 19b to be pierced via tube-like elements extending through the profiles 22 and 23, thereby forming the apertures for ventilating the motor vehicle wheel 10.

In FIG. 3, each of the hollow chambers 19a and 19b is bounded in each case by two frustoconically contoured profiles 22, 23 which are spaced apart in the axial direction and either by the hub 11 or by the rim 12 in the radial direction, namely by the rim 12 in the case of the cavity 19a and by the hub 11 in the case of the cavity 19b.

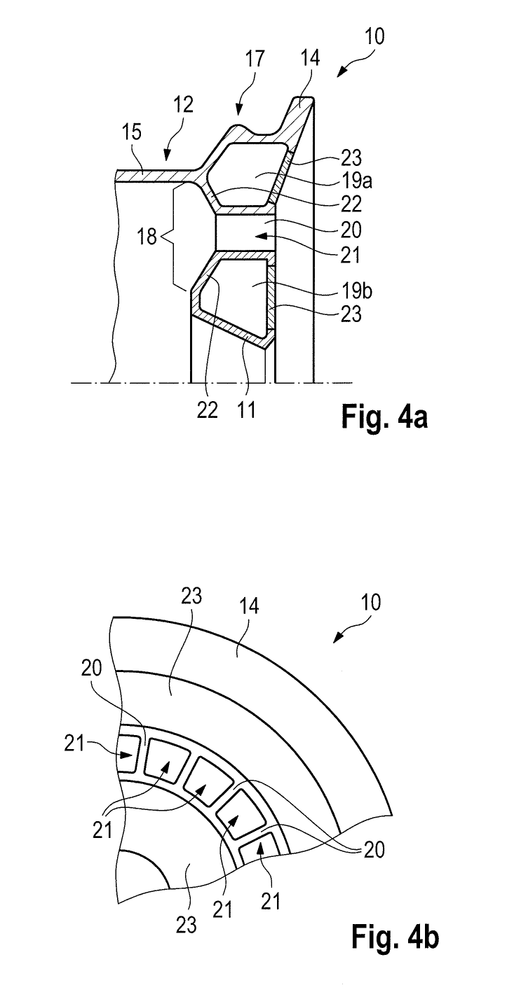

FIGS. 4a and 4b show a development of the exemplary embodiment of FIG. 3, in which intermediate elements 20 having apertures 21 positioned therebetween are formed, as seen in the radial direction, between the cavity 19a which directly adjoins the rim 12 and the cavity 19b which directly adjoins the hub 11.

As in the exemplary embodiment of FIGS. 1a, 1b and 2, the intermediate elements 20 are spokes 20 extending substantially in the radial direction.

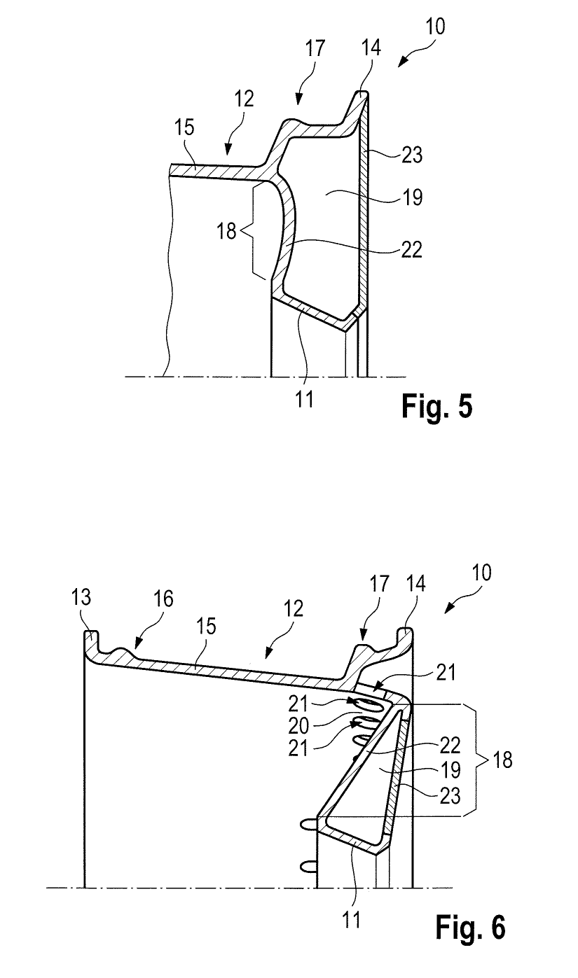

In the exemplary embodiment of FIG. 5, again a single hollow chamber 19 encircling in the circumferential direction is formed in the radial direction between the hub 11 and the rim 12, but in contrast to the exemplary embodiments of FIGS. 1a and 1b, said hollow chamber 19 extends completely in the radial direction between the hub 11 and the rim 12. Accordingly, in the exemplary embodiment of FIG. 5, as in the exemplary embodiment of FIG. 3, intermediate elements which form spokes, for example, are omitted.

However, in contrast to the exemplary embodiment of FIG. 3, there are not two hollow chambers 19a, 19b encircling in the circumferential direction, but rather just one single hollow chamber 19 which encircles in the circumferential direction but may be penetrated, however, by tube-like elements in order to form ventilation apertures for ventilating the wheel.

In FIG. 5, the cavity 19 is bounded radially by the hub 11 and the rim 12 and axially by two profiles 22 and 23, wherein the profile 22 is an integral part of the hub 11 and rim 12, and wherein the profile 23 is welded to the hub 11 and rim 12. The two profiles 22 and 23 are again preferably frustoconically contoured profiles.

FIG. 6 shows a further exemplary embodiment of a motor vehicle wheel according to aspects of the invention, which basically corresponds to the exemplary embodiment of FIGS. 1a and 1b, but differs from the exemplary embodiment of the FIGS. 1a and 1b in that there are not intermediate elements 20 designed as spokes extending substantially in the radial direction positioned between the cavity 19 adjoining the hub 11 in the radial direction and the rim 12, but rather, on the contrary, intermediate elements 20 which extend substantially in the axial direction and are designed as struts 20.

The struts extend substantially in the axial direction as an extension of the rim base 15. According to FIG. 6, the apertures 21 for ventilating the wheel 10 are introduced into said struts.

A common feature of all of the wheels 10 according to aspects of the invention is that, in the region of a “wheel disk” 18, i.e. between the hub 11 and the rim 12, said wheels have at least one hollow chamber 19, 19a, 19b encircling in the circumferential direction, in order thereby to provide a lightweight and stiff wheel which can absorb high loads.

The or each hollow chamber 19, 19a and 19b encircling in the circumferential direction can be segmented or subdivided here, as seen in the circumferential direction, into partial chambers.

The or each hollow chamber 19, 19a and 19b is preferably bounded by two frustoconical profiles 22, 23 which are spaced apart in the axial direction, and also radially by the rim 12 and/or the hub 11, wherein all of the elements of the wheel are preferably manufactured from a metallic material. One of the frustoconical segments is an integral part of the rim and/or hub, wherein the other frustoconically contoured profile is welded to the other assemblies of the wheel.

1. A motor vehicle wheel, with a radially inner hub and a radially outer rim, wherein the rim has an axially inner internal rim flange on a first side, which faces the motor vehicle in the installed position, an axially outer external rim flange on a second side, which faces away from the motor vehicle in the installed position, and a rim base which is positioned between said two rim flanges, wherein at least one hollow chamber encircling in a circumferential direction is formed in a radial direction between the rim and the hub in the region of the second side.

2. The motor vehicle wheel as claimed in claim 1, wherein the wheel has a single hollow chamber which encircles in the circumferential direction and directly adjoins the hub in the radial direction, wherein intermediate elements having apertures positioned therebetween in the circumferential direction are formed between the hollow chamber and the rim.

3. The motor vehicle wheel as claimed in claim 1, wherein the wheel has a single hollow chamber which encircles in the circumferential direction and directly adjoins the rim in the radial direction, wherein intermediate elements having apertures positioned therebetween in the circumferential direction are formed between the hollow chamber and the hub.

4. The motor vehicle wheel as claimed in claim 1, wherein the wheel has a single hollow chamber which encircles in the circumferential direction and extends between the rim and the hub.

5. The motor vehicle wheel as claimed in claim 1, wherein the wheel includes a first hollow chamber which directly adjoins the rim in the radial direction, and a second hollow chamber which directly adjoins the hub in the radial direction.

6. The motor vehicle wheel as claimed in claim 5, wherein intermediate elements having apertures positioned therebetween in the circumferential direction are formed between the first hollow chamber and the second hollow chamber.

7. The motor vehicle wheel as claimed in claim 2, wherein the intermediate elements are spokes extending substantially in the radial direction.

8. The motor vehicle wheel as claimed in claim 2, wherein the intermediate elements are struts extending substantially in the axial direction.

9. The motor vehicle wheel as claimed in claim 1, wherein the or each hollow chamber is bounded axially by in each case two frustoconically contoured profiles which are spaced apart in the axial direction, and radially by the hub and/or the rim.

10. The motor vehicle wheel as claimed in claim 9, wherein a first frustoconically contoured profile is an integral part of the hub and/or of the rim.

11. The motor vehicle wheel as claimed in claim 10, wherein a second frustoconically contoured profile is welded to the first frustoconically contoured profile and to the hub and/or to the rim.

12. The motor vehicle wheel as claimed in claim 1, wherein the or each hollow chamber encircling in the circumferential direction is subdivided in the circumferential direction into partial chambers.
